(19) United States
(12) Patent Application Publication
(10) Pub. No.: US 2019/0151178 A1
(43) Pub. Date: May 23, 2019

(54) PATIENT CEILING-HOIST CARRIAGE

(71) Applicant: Joerns Healthcare Limited, Worcestershire (GB)

(72) Inventors: Christopher Steven Westwood, Worcestershire (GB); Darryl Cain, Shatterford (GB)

(21) Appl. No.: 16/092,580

(22) PCT Filed: Apr. 12, 2017
(86) PCT No.: PCT/GB2017/051020

§ 371 Date: Oct. 10, 2018

(30) Foreign Application Priority Data
Apr. 18, 2016 (GB) 1606699.5

(51) Int. Cl. A61G 7/10

(52) U.S. Cl. CPC A61G 7/1042; B66D 3/26; A61G 7/1015

(57) ABSTRACT

There is disclosed patient ceiling-hoist carriage for the transport of a hoisted patient. The patient ceiling hoist carriage includes an electrically-operable motor, a carriage body, a patient ceiling-hoist connector connected to the carriage body and with which a patient-ceiling hoist is engagable, and a bogie. The bogie has a rail-engagement element and a baseplate which is connectable to the carriage body, the rail-engagement element having two axles which are in drivable engagement with the motor, each axle being in engagement with at least one rail-engagement wheel to allow the patient ceiling-hoist carriage to be driven along an associated patient ceiling-hoist carriage rail. The configuration such that, when the patient ceiling-hoist carriage is in a region of transition between two adjacent patient ceiling-hoist carriage rails, the two axles provide traction on both the adjacent patient ceiling-hoist carriage rails.

The present invention relates to a patient ceiling-hoist carriage, preferably but not exclusively for the transport of a hoisted patient. The invention further relates to a patient ceiling-hoist system having such a carriage, to a patient ceiling-hoist carriage device which may be retrofittable to existing patient ceiling-hoist carriages, and to a method of improving the smoothness of transport of a hoisted patient via a patient ceiling-hoist system.

Patient ceiling hoists or slings are devices which can be attached to a person to allow them to be transported from one place to another, typically being used for those who are less able-bodied. This transportation is achieved by provided a network of rails which define a track which can be followed by a carriage or trolley which is mounted to the rail. The patient ceiling hoist can then be mounted to the carriage.

Generally, such carriages will be provided with a motor to enable vertical actuation of the patient in the patient ceiling hoist, which allows for ease of insertion and removal of the patient from the hoist, whilst providing the necessary elevation to allow for horizontal transport.

To effect horizontal transport, the carriage and hoist can be manually moved, with the carriage rolling along the rail. This rolling of the carriage is relatively free, which means that obstacles to the motion of the carriage can prevent onward travel of the patient ceiling hoist.

Such obstacles might present in the form of dirt or grit in the rail, but can also occur where there is a slight discontinuity between adjacent rails in a rail network. The guiding wheels of the carriage may have a tendency to catch and become trapped by the discontinuity.

The present invention seeks to provide a patient ceiling-hoist carriage which overcomes the above-referenced problems.

According to a first aspect of the invention, there is provided a patient ceiling-hoist carriage for the transport of a hoisted patient, the patient ceiling hoist carriage comprising: an electrically-operable motor; a carriage body; a patient ceiling-hoist connector connected to the carriage body and with which a patient-ceiling hoist is engagable; and a bogie having a rail-engagement element and a baseplate which is connectable to the carriage body, the rail-engagement element having two axles which are in drivable engagement with the motor, each axle being in engagement with at least one rail-engagement wheel to allow the patient ceiling-hoist carriage to be driven along an associated patient ceiling-hoist carriage rail, such that, when the patient ceiling-hoist carriage is in a region of transition between two adjacent patient ceiling-hoist carriage rails, the two axles provide traction on both said adjacent patient ceiling-hoist carriage rails.

By providing a patient ceiling-hoist carriage which has a plurality of driven axles, horizontal transit of a patient ceiling hoist can be achieved without risking the possibility of the patient ceiling-hoist carriage becoming beached or lodged due to obstacles in the rail to which it is attached, for example, a discontinuity between two adjacent patient ceiling-hoist carriage rails.

Preferably, the rail-engagement element may comprise first and second rail-engagement sections which are spaced apart from one another at or adjacent to the baseplate, the two said axles being mounted to the first rail-engagement section, and the second rail-engagement section including at least one further axle which is in engagement with at least one further rail-engagement wheel. The first and second rail-engagement sections may be pivotably engagable with the baseplate to permit articulated motion of the patient ceiling-hoist carriage. Two said further axles may be provided on the second rail-engagement section. The or each second axle of the second rail-engagement section may be in drivable engagement with the or a further electrically-operable motor, or alternatively the or each further axle of the second rail-engagement section may be provided as a follower axle which is non-driven.

By providing an articulated unit, the patient ceiling-hoist carriage can readily navigate a non-linear patient ceiling-hoist carriage rail network. Providing the drive so as to be primarily upon one of the rail-engagement section, with the two driven axles being relatively closely spaced to one another, then jamming issues can be reduced, allowing the patient ceiling-hoist carriage to navigate rails having tight radii of curvature.

Optionally, the two said axles may be interconnected via a gear train which is drivable by the motor. An axis of a drive output of the motor may be in parallel to axes of the two said axles of the rail-engagement element.

By providing a single geared transmission from the motor output to the axles, the two axles can be driven synchronously, ensuring that there is no mismatch between the speed of rotation of the wheels. Directing the motor output so as to be in parallel with the axle directions simplifies the gear train, allowing it to be relatively compact. This means that the bulkier motorised components can be readily stowed within the patient ceiling-hoist carriage body, if desired.

In one embodiment, the bogie may be releasably engagable with the carriage body. Furthermore, the carriage body may include a recessed portion within which the baseplate of the bogie is receivable. Said recessed portion may include an articulation region to permit pivotable actuation of the rail-engagement element of the bogie.

By providing a releasably engagable bogie with the carriage body, maintenance of the patient ceiling-hoist carriage is advantageously simplified.

Preferably, the patient ceiling-hoist connector may be vertically actuatable relative to the carriage body.

In addition to the horizontal motion of the patient ceiling-hoist carriage, it is beneficial to provide a means of vertically adjusting the height of a patient ceiling hoist in a vertical direction. This allows for the patient ceiling hoist to advantageously be used by different patients of different heights, for instance.

Preferably, each of the two said axles may have a rail-engagement wheel at each end of the axle, each of the rail-engagement wheels being drivable via the axles. At least one of the rail-engagement wheels may include a circumferential gripping surface for improved engagement with the associated patient ceiling-hoist carriage rail.

The provision of captive rail-engagement wheels inside the patient ceiling-hoist carriage rail is one simple means of ensuring that the patient ceiling-hoist carriage is not only securely held in place, but also that it easily follows the course defined by the patient ceiling-hoist carriage rails.

There may be provided a carriage control circuit which is in communication with at least the motor and which is housed within the carriage body, and/or at least part of the motor may be housable within the carriage body.

The provision of onboard control electronics on the patient ceiling-hoist carriage removes the need for a separate bulky control unit, which may otherwise affect the ease of movement of the patient ceiling-hoist carriage in use.

According to a second aspect of the invention, there is provided a patient ceiling-hoist system comprising: a patient ceiling-hoist carriage preferably in accordance with the first aspect of the invention; a patient ceiling hoist engagable with the patient ceiling-hoist connector of the patient ceiling-hoist carriage; and a patient ceiling-hoist carriage rail, the patient ceiling-hoist carriage being engagable with and drivably movable along the patient ceiling-hoist carriage rail.

According to a third aspect of the invention, there is provided a patient ceiling-hoist carriage rail-engagement device comprising: an electrically-operable motor; and a rail-engagement element having two axles which are in drivable engagement with the motor, each axle being in engagement with at least one rail-engagement wheel engagable with an associated patient ceiling-hoist carriage rail.

An axis of a drive output of the motor may be in parallel to axes of the two said axles of the rail-engagement element, and additionally or alternatively, the two said axles may be interconnected via a gear train which is drivable by the motor.

The provision of a specific patient ceiling-hoist carriage rail-engagement device, which might be part of a bogie, allows an installer to provide a means of retrofitting the present drive arrangement to an existing patient ceiling-hoist carriage body, thereby negating the need for a wholesale replacement of an existing patient ceiling-hoist carriage system.

According to fourth aspect of the invention there is provided a method of improving the smoothness of transport of a hoisted patient via a patient ceiling-hoist system, the method comprising the steps of: a] connecting a patient ceiling-hoist carriage, preferably in accordance with the first aspect of the invention, to any one of a patient ceiling-hoist carriage rail of a plurality of patient ceiling-hoist carriage rails of the patient ceiling-hoist system; and b] driving both the axles using the motor of the patient ceiling-hoist carriage such that, in a region of transition between first and second adjacent said patient ceiling-hoist carriage rails, one said axle is drivably positionable on the first adjacent patient ceiling-hoist carriage rail, and the other said axle is drivably positionable on the second adjacent patient ceiling-hoist carriage rail, thereby improving a smoothness of transition across a join between the first and second adjacent patient ceiling-hoist carriage rails for the patient ceiling-hoist carriage.

The invention will now be more particularly described, by way of example only, with reference to the accompanying drawings, in which:

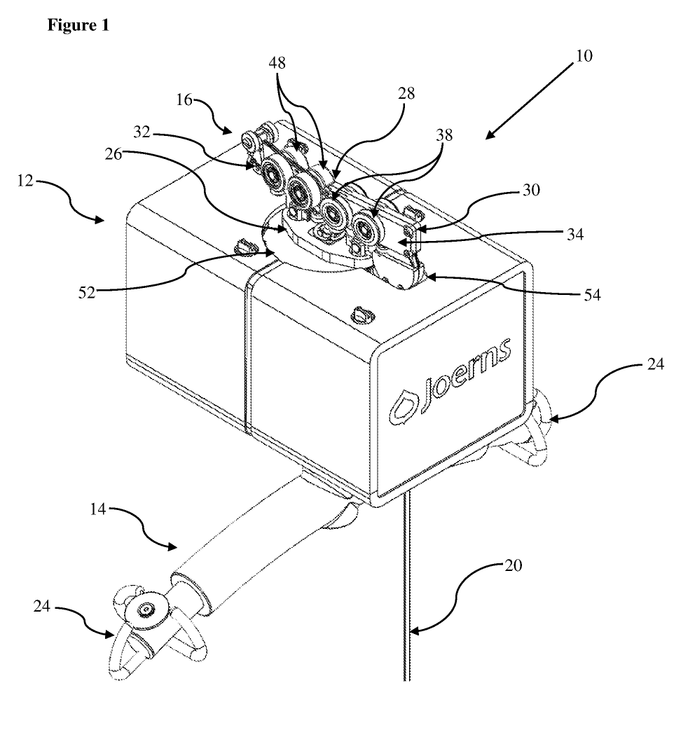

FIG. 1 shows a perspective representation of one embodiment of a patient ceiling-hoist carriage in accordance with the first aspect of the invention;

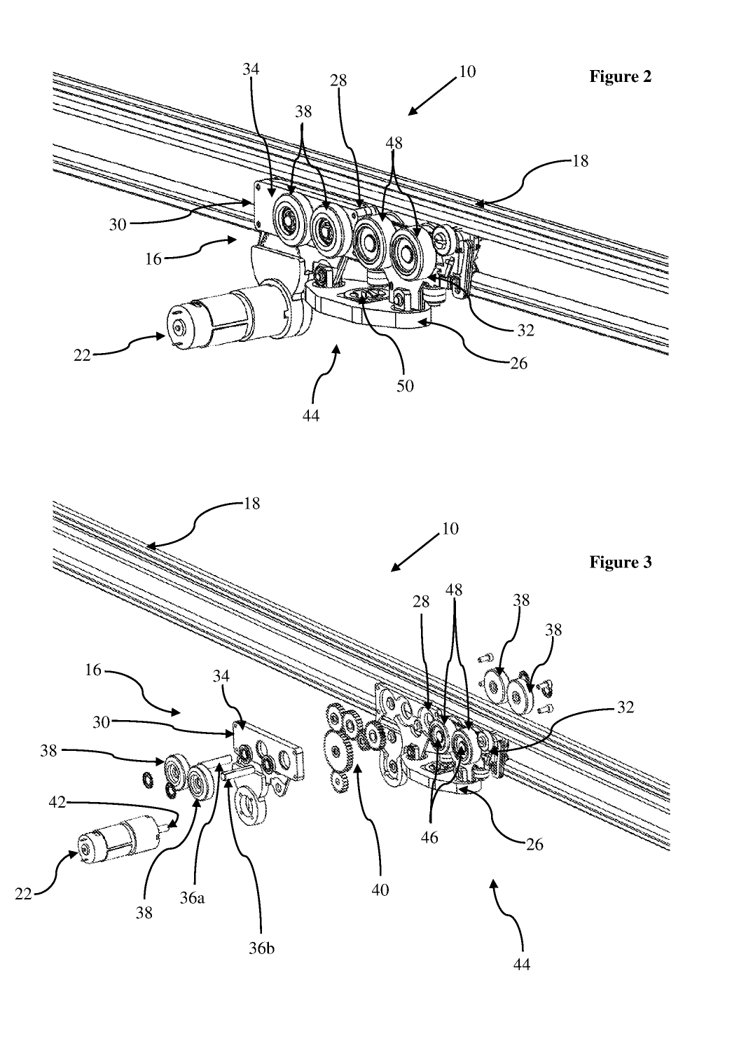

FIG. 2 shows a perspective representation of the bogie of the patient ceiling-hoist carriage of FIG. 1, in engagement with a cut-away representation of a patient ceiling-hoist carriage rail; and

FIG. 3 shows an exploded perspective representation of the bogie of FIG. 2.

Referring firstly to FIG. 1, there is shown a patient ceiling-hoist carriage which is indicated globally at 10 which is used in the transportation of a patient hoisted by an associated patient ceiling hoist.

The patient ceiling-hoist carriage 10 comprises a carriage body 12 within which the electrical components, such as a carriage control circuit, of the patient ceiling-hoist carriage 10 may be housed, a patient ceiling-hoist connector 14 via which a patient ceiling hoist may be engaged, and a trolley or bogie 16 which is engagable with a patient ceiling-hoist carriage rail 18, such as that shown in FIGS. 2 and 3. Also visible is an emergency stop cord 20 which may be used by a patient or carer to bring the patient ceiling-hoist carriage 10 to a halt if necessary.

The carriage body 12 may be formed as a resilient unit which encases the electronic components of the patient ceiling-hoist carriage 10 and also potentially at least in part house an electrically-operable motor 22 associated with the bogie 16. The patient ceiling-hoist connector 14 may, as illustrated, be formed as a connector arm having one or more hooks 24 which may engage with ropes or wires of a patient ceiling hoist so as to elevate a patient received in the patient ceiling hoist. As indicated, the patient ceiling-hoist connector 14 would typically depend from a vertically lowermost surface of the carriage body 12, though any suitable arrangement to permit a ceiling hoist to be attached could be considered. The patient ceiling-hoist connector 14 is typically, but not necessarily, actuatable in a vertical direction, so as to be able to alter an elevation of the patient ceiling hoist attached thereto.

The bogie 16 is formed having a baseplate 26 which may be connectable, releasably or otherwise, to the carriage body 12, and a rail-engagement element 28 which allows for the patient ceiling-hoist carriage 10 to be connected to a ceiling-mounted patient ceiling-hoist carriage rail 18.

The rail-engagement element 28 may preferably be an articulated element to allow for ready navigation of curved patient ceiling-hoist carriage rails, and thus may, as illustrated, be formed having first and second, typically front and rear wheeled sections 30, 32. Evidently, front and rear are directional indicators for reference only; the patient ceiling-hoist carriage 10 will typically be capable of both forwards and rearwards travel, in which case there will be no distinction between forward and rearward directions. In the present embodiment, the first wheeled section 30 is driven by the motor 22, whereas the second wheeled section 32 is a non-driven or follower member. However, it will be appreciated that the second wheeled section 32 could also be driven, or dispensed with entirely so as to provide a non-articulated patient ceiling-hoist carriage 10.

The first wheeled section 30 of the rail-engagement element 28 a, preferably elongate, body portion 34 having two parallel axles 36a, 36b positioned therethrough. Each axle 36a, 36b to at least one rail-engagement wheel 38, the two axles 36a, 36b being sufficiently spaced apart along the body portion 34 to permit rotation of all rail-engagement wheels 38. Preferably, the spacing between the first and second axles 36a, 36b is as small as possible without causing a clash between the rail-engagement wheels 38; this ensures that the patient ceiling-hoist carriage 10 can traverse a patient ceiling-hoist carriage rail 18 having a tight curvature.

Both axles 36a, 36b are in drivable engagement with the motor 22, as can best be seen from FIG. 3, preferably via a conjoined gear train 40 to ensure coupled rotation of both axles 36a, 36b simultaneously by an output 42 of the motor 22. However, each axle 36a, 36b could be separately driven, or an alternative coupling mechanism from the motor output 42 could be provided.

It is noted that the device shown in FIGS. 2 and 3 could be considered to be a patient ceiling-hoist carriage rail-engagement device 44, and therefore could be provided in isolation from the rest of the patient ceiling-hoist carriage 10, to thereby allow the patient ceiling-hoist carriage rail-engagement device 44 to be retro-fitted to existing patient ceiling hoist systems. Such a device 44 could be provided as a single unit including just the first wheeled section 30 in connection with the motor 22, which could then be coupled to, for instance, an existing baseplate and second wheeled section. However, the patient ceiling-hoist carriage rail-engagement device 44 could be provided as a whole unit inclusive of one or more of a baseplate 26 and a second wheeled section 32.

The rail-engagement wheels 38 are here provided so as to be engaged with each end of each axle 36a, 36b, thereby forming four driven wheels 38. However, in order to produce the necessary driving force, there only need be one driven wheel 38 per axle 36a, 36b, with other freewheeling wheels being provided for balance only.

The second wheeled section 32 of the bogie 16 is largely similarly formed to the first wheeled section 30 having two spaced apart rear axles 46 which are engaged with follower wheels 48 which are similarly engagable with the patient ceiling-hoist carriage rail 18. However, in the depicted embodiment, there is no coupling to the rear axles 46 from the motor output 42. This could, however be provided if desired, and/or a further motor could be provided as a dedicated driver for the rear wheeled section 32.

Each of the first and second wheeled sections 30, 32 may preferably be engagable independently with the baseplate 26, preferably being in pivotable engagement to effect articulation between the first and second wheeled sections 30, 32.

The baseplate 26 may be provided as a substantially planar plate having a coupling slot 50 via which the bogie 16 may be connected to the carriage body 12. However, the baseplate 26 could alternatively be coupled to the carriage body 12 using an alternative form of releasable fastener, such as screw-threaded fasteners, or could be fixedly connected to the carriage body 12.

As can be seen in FIG. 1, the carriage body 12 may include a recessed portion 52 within which the baseplate 26 of the bogie 16 is receivable. The recessed portion 52 may also include a further recess 54 at or adjacent to the first wheeled section 30 of the bogie 16, through which a coupling between the motor 22 and the body portion 34 of the first wheeled section 30 is positionable. This further recess 54 may be shaped so as to improve the ease with which pivotable articulation of the first wheeled section 30 can be achieved, whilst also allowing the motor 22 to be housed within the carriage body 12. It will be appreciated, however, that the further recess 54 may be dispensed with in the event that the motor 22 is to be housed exterior to the carriage body 12.

In use, the patient ceiling-hoist carriage 10 can be driven across one or more patient ceiling-hoist carriage rails 18 which may form a definite track along which the patient ceiling-hoist carriage 10 can travel. The necessary traction can be achieved by activation of the motor 22 to drive the drivable axles 36a, 36b of the bogie 16, the rail-engagement wheels 38 gripping an interior to the patient ceiling-hoist carriage rails 18 to effect this motion. The rail-engagement wheels 38 may be provided with an improved gripping surface around their circumferences to assist with this.

The provision of two drivable axles 36a, 36b on the bogie 16 provides an improved driving force to ensure that the patient ceiling-hoist carriage 10 is better able to overcome obstacles to its transit, for example, a discontinuity where two adjacent patient ceiling-hoist rails 18 may meet.

As the patient ceiling-hoist carriage 10 approaches such a discontinuity, for instance, a forwardmost set of rail-engagement wheels 38, associated with a first, forwardmost of the two axles 36a will enter the region of discontinuity, and may experience a reduced gripping force on one or both of the adjacent patient ceiling-hoist carriage rails 18. However, the second, rearward axle 36b is spaced apart from the first axle 36a so as to still remain in full engagement with one or other of the patient ceiling-hoist carriage rails 18, and therefore continue to apply a sufficiently strong driving force.

As the patient ceiling-hoist carriage 10 crosses the discontinuity, the rail-engagement wheels 38 of the first axle 36a will come into contact with a second of the patient ceiling-hoist carriage rails 18, and will be able to fully engage therewith and apply its own driving force. This will allow the patient ceiling-hoist carriage 10 to advance such that the second axle 36b and associated rail-engagement wheels 38 bridge the discontinuity. Using this approach, the patient ceiling-hoist carriage 10 can enter a position in which the axles 36a, 36b can span the discontinuity, allowing the patient ceiling-hoist carriage 10 to be driven powerfully across the discontinuity without being impeded.

It will be appreciated that existing patient ceiling-hoist carriage systems could be upgraded so as to have a drive arrangement as per the present invention. This may be achieved by providing a patient ceiling-hoist carriage rail-engagement device 44, such as that shown in FIGS. 2 and 3, either as a full bogie device including the motor 22, the baseplate 26 and both of the first and second wheeled sections 30, 32, or could be provided as simply as the first wheeled section 30 in combination with the motor 22. The patient ceiling-hoist carriage rail-engagement device 44 could then be attached to an existing patient ceiling-hoist carriage, without necessarily needing to replace all of the existing electronics.

It is therefore possible to provide a patient ceiling-hoist carriage which has first and second driven axles so as to improve the resilience of the carriage to obstacles to horizontal motion along a network of patient ceiling-hoist carriage rails. This is achieved by positioning the axles in such a fashion as to be able to drive on both sides of a discontinuity between adjacent patient ceiling-hoist carriage rails, thereby generating the necessary driving force to bridge the gap.

The words ‘comprises/comprising’ and the words ‘having/including’ when used herein with reference to the present invention are used to specify the presence of stated features, integers, steps or components, but do not preclude the presence or addition of one or more other features, integers, steps, components or groups thereof.

It is appreciated that certain features of the invention, which are, for clarity, described in the context of separate embodiments, may also be provided in combination in a single embodiment. Conversely, various features of the invention which are, for brevity, described in the context of a single embodiment, may also be provided separately or in any suitable sub-combination.

The embodiments described above are provided by way of examples only, and various other modifications will be apparent to persons skilled in the field without departing from the scope of the invention as defined herein.

1. The patient ceiling-hoist carriage for the transport of a hoisted patient, the patient ceiling hoist carriage comprising:
an electrically-operable motor;
a carriage body;
a patient ceiling-hoist connector connected to the carriage body and with which a patient-ceiling hoist is engagable; and
a bogie having a rail-engagement element and a baseplate which is connectable to the carriage body, the rail-engagement element having two axles which are in drivable engagement with the motor, each axle being in engagement with at least one rail-engagement wheel to allow the patient ceiling-hoist carriage to be driven along an associated patient ceiling-hoist carriage rail, such that, when the patient ceiling-hoist carriage is in a region of transition between two adjacent patient ceiling-hoist carriage rails, the two axles provide traction on both said adjacent patient ceiling-hoist carriage rails.

2. The patient ceiling-hoist carriage as claimed in claim 1, wherein the rail-engagement element comprises first and second rail-engagement portions which are spaced apart from one another at or adjacent to the baseplate, the two said axles being mounted to the first rail-engagement section, and the second rail-engagement section including at least one further axle which is in engagement with at least one further rail-engagement wheel.

3. The patient ceiling-hoist carriage as claimed in claim 2, wherein the first and second rail-engagement sections are pivotably engagable with the baseplate to permit articulated motion of the patient ceiling-hoist carriage.

4. The patient ceiling-hoist carriage as claimed in claim 1, wherein each of the two said axles has a rail-engagement wheel at each end of the axle, each of the rail-engagement wheels being drivable via the axles.

5. The patient ceiling-hoist carriage as claimed in claim 2, wherein two said further axles are provided on the second rail-engagement section.

6. The patient ceiling-hoist carriage as claimed in claim 2, wherein the or each further axle of the second rail-engagement portion is in drivable engagement with the or a further electrically-operable motor or is provided as a follower axle which is non-driven.

7. (canceled)

8. The patient ceiling-hoist carriage as claimed in claim 1, wherein the two said axles are interconnected via a gear train which is drivable by the motor.

9. The patient ceiling-hoist carriage as claimed in claim 1, wherein an axis of a drive output of the motor is in parallel to axes of the two said axles of the rail-engagement element.

10. The patient ceiling-hoist carriage as claimed in claim 1, wherein the bogie is releasably engagable with the carriage body.

11. The patient ceiling-hoist carriage as claimed in claim 1, wherein the carriage body includes a recessed portion within which the baseplate of the bogie is receivable.

12. The patient ceiling-hoist carriage as claimed in claim 1, wherein the recessed portion includes an articulation region to permit pivotable actuation of the rail-engagement element of the bogie.

13. The patient ceiling-hoist carriage as claimed in claim 1, wherein the patient ceiling-hoist connector is vertically actuatable relative to the carriage body.

14. The patient ceiling-hoist carriage as claimed in claim 1, further comprising a carriage control circuit which is in communication with at least the motor and which is housed within the carriage body.

15. The patient ceiling-hoist carriage as claimed in claim 1, wherein at least part of the motor is housable within the carriage body.

16. The patient ceiling-hoist carriage as claimed in claim 1, wherein each of the two said axles has a rail-engagement wheel at each end of the axle, each of the rail-engagement wheels being drivable via the axles.

17. The patient ceiling-hoist carriage as claimed in claim 1, wherein at least one of the rail-engagement wheels includes a circumferential gripping surface for improved engagement with the associated patient ceiling-hoist carriage rail.

18. (canceled)

19. A patient ceiling-hoist carriage rail-engagement device comprising:
an electrically-operable motor; and
a rail-engagement element having two axles which are in drivable engagement with the motor, each axle being in engagement with at least one rail-engagement wheel engagable with an associated patient ceiling-hoist carriage rail.

20. The patient ceiling-hoist carriage rail-engagement device as claimed in claim 17, wherein an axis of a drive output of the motor is in parallel to axes of the two said axles of the rail-engagement element.

21. The patient ceiling-hoist carriage rail-engagement device wherein the two said axles are interconnected via a gear train which is drivable by the motor.

22. A method of improving the smoothness of transport of a hoisted patient via a patient ceiling-hoist system, the method comprising the steps of:
a] connecting the patient ceiling-hoist carriage as claimed in claim 1, to any one of a patient ceiling-hoist carriage rail of a plurality of patient ceiling-hoist carriage rails of a patient ceiling-hoist system; and
b] driving both the axles using the motor of the patient ceiling-hoist carriage such that, in a region of transition between first and second adjacent said patient ceiling-hoist carriage rails, one said axle is drivably positionable on the first adjacent patient ceiling-hoist carriage rail, and the other said axle is drivably positionable on the second adjacent patient ceiling-hoist carriage rail, thereby improving a smoothness of transition across a join between the first and second adjacent patient ceiling-hoist carriage rails for the patient ceiling-hoist carriage.
